(19) United States
(12) Patent Application Publication
(10) Pub. No.: US 2025/0246750 A1
(43) Pub. Date: Jul. 31, 2025

(54) BATTERY CELL HOUSING AND BATTERY CELL

(71) Applicant: Hoerbiger Antriebstechnik Holding GmbH, Schongau (DE)

(72) Inventor: Christian REUMÜLLER, Schongau (DE)

(21) Appl. No.: 19/035,370

(22) Filed: Jan. 23, 2025

(30) Foreign Application Priority Data
Jan. 30, 2024 (DE) 1020240102642.1

(51) Int. Cl. H01M 50/342; H01M 50/103

(52) U.S. Cl. CPC H01M 50/3425; H01M 50/103

(57) ABSTRACT

A battery cell housing for a prismatic battery cell having a housing shell and a housing base that is configured as a separate part is shown. The housing base has a pressure compensation element integrated therein which is defined by at least one area the material thickness of which is reduced compared to an area directly adjacent thereto. The housing shell and the housing base are made of different materials and have different wall thicknesses.

Furthermore, a battery cell is shown.

### TECHNICAL FIELD

The disclosure relates to a battery cell housing for a prismatic battery cell and to such a prismatic battery cell.

### BACKGROUND

Prismatic battery cells are primarily employed in the automotive industry as components of high-voltage energy storage devices for electric or hybrid vehicles. Such prismatic battery cells usually include a battery cell housing shell that is open on one side and closed by a cover having two terminals. The battery cell housing is cuboid in shape here, allowing prismatic battery cells to be installed in a space-saving manner. In principle, the battery cell housing is produced from metal or a metal alloy so that the necessary mechanical strength, tightness and thermal requirements are satisfied.

In the event of a defect or even a fire in a battery cell, this leads to overpressure in the battery cell and of the entire high-voltage energy storage. Such a situation may be caused, for example, by an overheating of the battery cell due to overloading, a short circuit or overcharging.

In order to prevent uncontrolled leakage of chemicals and/or flames in such critical situations, a pressure compensation must take place in good time. For pressure compensation, valves or burst elements are usually installed as pressure compensation elements in the battery cell housing. Here, burst elements are preferred to valves for reasons of space and cost.

Hitherto, the battery cell housings for prismatic battery cells have been manufactured by extrusion, bar extrusion, bending, welding and/or roll forming, with bending and welding being the economically preferred processes. However, it may be necessary to manufacture the burst element from a different material than the rest of the cell housing, so that the burst element has to be inserted into the cell housing in a further step. Generally, direct integration of the burst element using current manufacturing methods is very complex and expensive.

Accordingly, it is an object of the disclosure to provide a battery cell housing which is simple and quick to manufacture, thus reducing production costs and continuing to meet all safety standards.

### SUMMARY

A battery cell housing for a prismatic battery cell according to the present disclosure includes a housing shell and a housing base that is configured as a separate part and closes an open side of the housing shell. The housing base has a pressure compensation element integrated therein which is defined by at least one area the material thickness of which is reduced compared to an area directly adjacent thereto. The housing shell and the housing base are made of different materials here, e.g. of different metal alloys, and have different wall thicknesses. In other words, due to the fact that the housing shell and the housing base are different parts that are produced separately from each other by using a material for the housing shell which is different from the material of the housing base, a hybrid, two-part battery cell housing is created. The pressure compensation element can be integrated directly into the housing base here without significantly increasing the production costs or making the manufacturing process more difficult. This allows the housing shell and the housing base to be manufactured independently of each other, so that the respective requirements for the components of the battery cell housing can be realized more easily and cost-effectively.

The housing shell and the housing base are produced e.g. from common metal materials, for example metal alloys, which are available as a coil, that is, as a metal strip wound on a spool. To manufacture the housing shell, an endless tube is e.g. produced by contour roll forming, e.g. by roll forming, while only an endless profile or section is required to manufacture the housing base. In this way, the battery cell housing can be produced quickly, simply and cost-effectively. The fact that the housing base is not made from the material of the housing shell allows it to be adapted in an optimum fashion to the necessary properties required of the pressure compensation element.

According to the disclosure, a battery cell housing is to be understood to be a housing for a single battery cell. In the case of a prismatic battery cell, the battery cell housing is therefore the cell housing surrounding the stacked anode and cathode packs, which are also referred to as cell stacks.

The pressure compensation element according to the disclosure is E.g. a burst element. In addition to the spatial advantages of a burst element already mentioned, burst elements are furthermore preferable to a pressure compensating valve as a pressure compensation element for the following reasons. A burst diaphragm will burst when a limit value is exceeded and thus quickly and easily opens up a maximum flow cross-section to equalize the pressure. In addition, with a burst element, no unintentional escape of a fluid will occur.

According to one embodiment, the pressure compensation element is defined by at least one line of weakness or includes at least one line of weakness. The line of weakness may be designed to be U- or C-shaped. Alternatively, star-shaped lines of weakness may also be provided. The lines of weakness define predetermined breaking points so that the housing base will burst along the lines of weakness if the pressure in the battery cell exceeds a limit value defined by the pressure compensation element.

The arrangement of the line or lines of weakness in the housing base can furthermore create an advantageous flow so that the pressure is compensated as quickly as possible. In addition, the lines of weakness make it possible to provide the maximum flow cross-section without any great delays.

The line of weakness may be a groove, e.g. a groove starting from the outer face of the battery cell housing. This means that the line of weakness can be produced easily, quickly and cost-effectively.

The groove can be stamped into the housing base here and has a U- or V-shaped cross-section.

According to an example, the pressure compensation element is defined by a recessed, flat section in the housing base. The wall thickness of this section is less than the wall thickness of the rest of the housing base. The wall thickness of the recessed, flat section is e.g. 25 to 80%, or 25 to 50%, smaller than the wall thickness of the rest of the housing base outside the pressure compensation element. In other words, the recessed, flat section in the housing base of the pressure compensation element corresponds to a burst diaphragm, which ruptures when the pressure inside the battery cell exceeds a limit value. In this way, a defined fluid flow for pressure compensation can be ensured, which facilitates rapid and effective pressure compensation.

Preferably, the recessed, flat section forming the pressure compensation element includes the line of weakness at least in sections at its edge section. As a result, the pressure compensation element may burst along the line of weakness, and the recessed, flat section can be bent outward by the pressure in advance so that a maximum flow cross-section is opened. Due to the difference in thickness, the area outside the recessed section remains stable as desired when there is a pressure increase. This measure also allows the stresses in the line of weakness to be increased so that the tearing-open process can be precisely predetermined.

The line of weakness may extend in a C- or U-shape along the edge section of the recessed, flat section. In this way, it can be ensured that the recessed, flat section, which is framed by the C or U, remains firmly connected to the housing base after the tearing process and will not become detached from the housing base even in the event of bursting along the line of weakness.

According to one embodiment, the housing shell is a U-shaped profile having an open side that is closed by the housing base.

The housing shell and the housing base may define a battery cell housing that is open on both sides at the face sides; the open face sides can each be closed by a cover having a terminal. Here, the battery cell housing may be longer than the classic prismatic cell housing.

According to a preferred embodiment, the housing shell has a smaller wall thickness than the housing base. The largest wall thickness of the housing base can be twice to four times as large as the largest wall thickness of the housing shell.

For example, the wall thickness of the housing shell is between 0.2 mm and 2 mm, while the wall thickness of the housing base outside the line of weakness and the recessed area, if any, is between 0.4 mm and 4 mm.

The pressure compensation element may occupy a surface area of 10 to 30% of the total surface area of the outer face of the housing base. The surface area occupied by the pressure compensation element may be at least 20 mm² and at most 4,000 mm². This allows a fast, effective and defined pressure compensation to be ensured in critical situations.

According to one embodiment, the pressure compensation element is designed to withstand a pressure of at least 2 bar. This means that the limit value for the pressure inside the battery cell is at least 2 bar. For example, the limit value is between 2 and 25 bar. In this context, it is important that the pressure compensation element is able to permanently withstand up to 90% of the limit value in order to prevent an unintentional pressure relief. Even normal operation may result in load and temperature fluctuations in the battery cell, which cause normal pressure fluctuations. However, these normal pressure fluctuations do not need to be compensated by the pressure compensation element. A high limit value pressure can therefore prevent damage to the pressure compensation element caused by pressure fluctuations during normal operation.

In order to allow such pressure fluctuations of normal operation to be compensated for even more effectively, the pressure compensation element may be combined with a compensation diaphragm in addition to the burst diaphragm, i.e. the recessed, flat section.

According to one embodiment, the housing base is a flat section which is connected to the edge of the housing shell on its opposite longitudinal sides. For example, the housing shell and the housing base are connected in such a way that, in conjunction with the covers for the open face sides, they provide a hermetic battery cell housing. The connection between the housing base and the housing shell is e.g. an irreversible connection, which is produced by a material- bonding joining process. This includes, for example, laser welding, friction stir welding, etc.

The housing base may be made of a different metal or a different metal alloy than the housing shell, with the housing base and the housing shell being in welded to each other. This allows a hermetic battery cell housing to be provided despite the hybrid, two-part configuration.

According to a preferred embodiment, the housing base has, on its outer edge, a shoulder in which the edge of the housing shell is seated. Since the housing shell and the housing base create an interlocking fit due to the shoulder, centering of the housing shell is facilitated so that the manufacturing process can be accelerated.

Preferably, the housing base is a one-piece body and the pressure compensation element continues integrally and non-welded into the adjacent area of the housing base. In other words, the pressure compensation element is integrated directly in the housing base, as a result of which any unintentional loosening of a weld seam between the pressure compensation element and the housing base can be prevented. Accordingly, such a one-piece embodiment provides a more stable and tight battery cell housing.

Furthermore, the object is achieved according to the disclosure by a battery cell having a battery cell housing as described above, wherein at least one anode and at least one cathode are accommodated in the battery cell housing.

### BRIEF DESCRIPTION OF THE DRAWINGS

Further advantages and features of the disclosure will be apparent from the description below and from the drawings, to which reference is made and in which:

FIG. 1 shows a schematic perspective representation of a battery cell according to the disclosure with its battery cell housing according to the disclosure;

FIG. 2 shows a cross-section of the battery cell housing shown in FIG. 1;

FIG. 3 shows a cross-section of the housing base of the battery cell housing along the sectional line A-A in FIG. 1; and

FIG. 4 shows a schematic representation of a battery cell according to the disclosure in the cut-open state.

### DETAILED DESCRIPTION

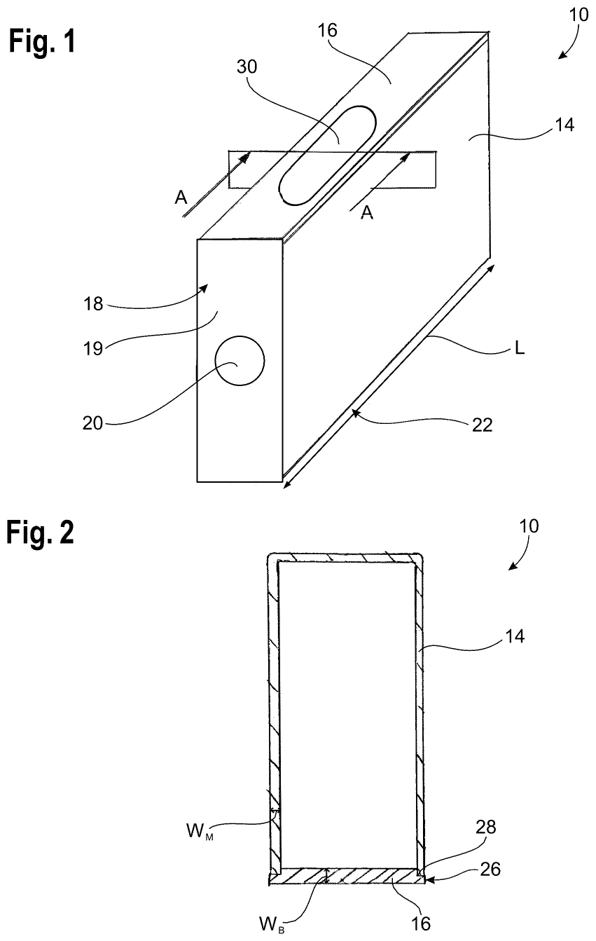

FIG. 1 shows a prismatic, in this case cuboid battery cell 12 having a battery cell housing 10. The battery cell 12 is intended e.g. for use in the automotive industry.

The battery cell housing 10 that can be seen in FIG. 1 consists, inter alia, of a housing shell 14 that is U-shaped in cross-section and a housing base 16 that is configured as a separate part and closes the open side of the U and thus the profile in the circumferential direction. In the embodiment shown here, the two face sides 18 of the battery cell housing 10 are formed neither by the housing shell 14 nor by the housing base 16.

Rather, in the optional variant shown, the face sides 18 are covered and closed by a respective cover 19 having a terminal 20 of the battery cell 12.

Alternatively, a cover 19 having two terminals 20 may also be provided, or else the terminals 20 may be integrated in the housing base 16. It is only important that the battery cell housing 10 together with the cover 19 or covers 19 constitute a hermetically sealed battery cell housing 10.

As mentioned above, the housing shell 14 is in the form of a U-shaped profile.

The U-shaped profile or section of the housing shell 14 is preferably produced by contour roll forming, e.g. roll forming of a coil. The coil in question here is a metal strip wound on a spool.

By producing the housing shell 14 from a coil, the housing shell 14 can be produced as an endless profile or section and subsequently cut to the desired length L of the housing shell 14.

The housing base 16 is a flat section, which is also produced from a coil. An endless section can be produced from the coil, which was made in the same way as before for the housing shell 14 and is cut to the desired length L.

Since the housing shell 14 and the housing base 16 are manufactured from different coils as separate parts independently of each other, the housing shell 14 may be produced from a different material than the housing base 16.

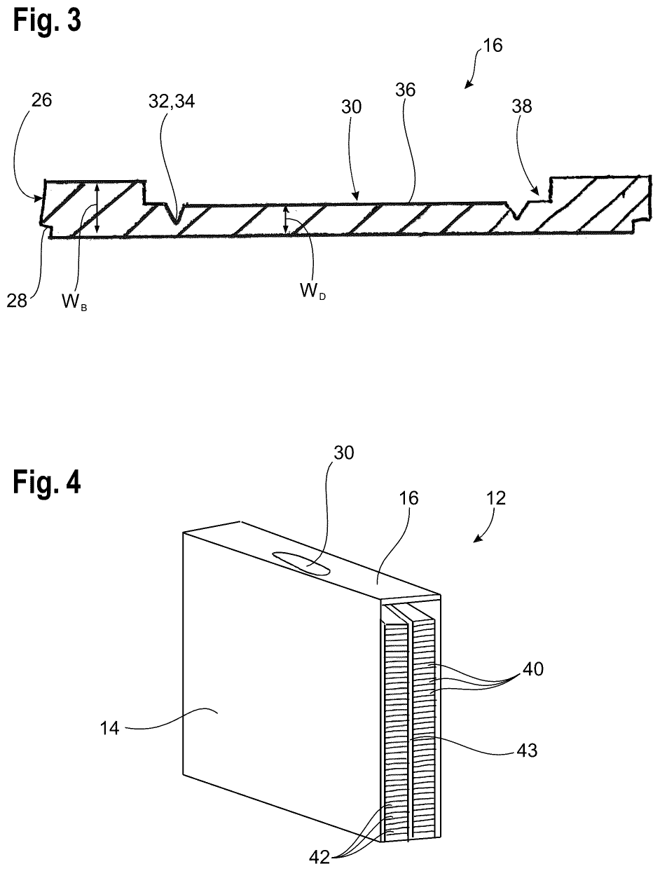

In order to allow the housing shell 14 and the housing base 16 to be connected to each other more easily, the housing base 16 has a shoulder 28 along its outer edge 26 (see FIG. 3), in which the edge 24 of the housing shell 14 is seated or on which it rests.

This shoulder can be created during the forming of the housing base.

To close the housing shell 14, a respective edge 24 of each leg of the U on the open side of the housing shell 14 is inserted into the shoulder 28 on the opposite longitudinal sides 22 of the housing base 16.

Since both the housing shell 14 and the housing base 16 are made of metal materials, e.g. pure metals or metal alloys, the housing shell 14 and the housing base 16 can be welded to each other. In this process, the housing shell 14 and the housing base 16 are irreversibly connected to each other, preferably by laser welding or friction stir welding. Alternatively, other material-bonding joining methods or further commonly used fastening methods for adhesion or cohesion can also be used.

FIG. 2 clearly shows that the wall thickness W_{M} of the housing shell 14 is smaller than the wall thickness W_{B} of the housing base 16. Here, the largest wall thickness W_{B} of the housing base 16 is preferably twice to four times as large as the largest wall thickness W_{M} of the housing shell 14.

The wall thickness W_{M} of the housing shell 14 is preferably constant.

In principle, the housing shell 14 may have a wall thickness W_{M} of between 0.2 mm and 2 mm. The housing base 16, on the other hand, has a greatest wall thickness W_{B}, which is between 0.4 mm and 4 mm, where, as discussed, W_{B}>W_{M}.

The difference in the wall thickness W_{M} of the housing shell 14 and the wall thickness W_{B} of the housing base 16 is required, among other things, for the stability of the battery cell housing 10. In addition, the use of different materials for the housing shell 14 and the housing base 16 can result in different wall thicknesses W_{M}, W_{B}.

Furthermore, the housing base 16 has a pressure compensation element 30 integrated therein in the form of a recessed, flat section 36, the material thickness W_{D} of which is reduced in comparison to the wall thickness W_{B} of the rest of the housing base 16. This can be seen in FIG. 3.

The pressure compensation element 30 has at least one line of weakness 32, which here (optionally) extends along the edge of the recessed section 36 at some distance from the edge. The line of weakness 32 defines a predetermined breaking point here, along which the pressure compensation element 30 breaks open in a critical situation in order to enable rapid and effective pressure compensation.

For example, the line of weakness 32 is in the form of a groove 34, which is stamped into the housing base 16 from the outside of the battery cell housing 10, see FIG. 3. Groove 34 is configured with a V-shaped cross-section. Alternatively, the line of weakness 32 may also have a U-shaped or rectangular cross-section.

The wall thickness W_{D} of the recessed, flat section 36 can be 25 to 50% smaller than the wall thickness W_{B} of the rest of the housing base 16.

The recessed, flat section 36 thus defines a burst diaphragm, which will burst when there is a pressure inside the battery cell 12 that exceeds a predefined limit value, so that a maximum flow cross-section is released for pressure compensation. This limit value is also referred to as the response pressure.

However, the recessed, flat section 36 must not be constructed to have a wall thickness W_{D} that is too thin, since normal operation of the battery cell 12 already results in load and temperature changes that cause pressure fluctuations. In order to be able to better compensate for the pressure fluctuation of normal operation, the pressure compensation element 30 may additionally comprise a compensation diaphragm, which is not shown here for reasons of clarity.

The limit value above which the pressure compensation element 30 is activated is between 2 and 25 bar. This means that the pressure compensation element 30 has to be able to withstand a pressure of at least 2 bar.

In order to prevent unintentional activation of the pressure compensation element 30, the pressure compensation element 30 is preferably designed such that it is able to permanently withstand a pressure in the interior of the battery cell 12 which amounts to 90% of the limit value, i.e. which amounts to 90% of the response pressure.

The pressure compensation element 30 will rupture along the lines of weakness 32 when the limit value of the pressure within the battery cell 12 is exceeded, with up to 95% of the recessed, flat section 36 being opened and rapid and effective pressure compensation being allowed to take place.

Preferably, the line of weakness 32 here extends in a U- or C-shape along the edge of the recessed section 36 in a top view, so that the recessed, flat section 36 of the pressure compensation element 30 remains firmly connected to the housing base 16 at least at one point. In this way, it can be ensured that the pressure compensation element 30 will not fly away in an uncontrolled manner due to the high pressure inside the battery cell 12.

In order to be able to ensure a continuous attachment of the pressure compensation element 30 to the housing base 16 at at least one point, the housing base 16 is a one-piece body, with the pressure compensation element 30 continuing integrally and non-welded into the adjacent area of the housing base 16.

Therefore, the pressure compensation element 30 is produced in the housing base 16 by material removal and/or reshaping and is thus directly integrated therein.

A different variant provides for the housing base 16 to be configured without a recessed section 36, so that the pressure compensation element 30 is defined only by the line of weakness 32, which may be formed as previously discussed.

FIG. 4 shows the entire prismatic battery cell 12 with the battery cell housing 10 in a cut-open view. Here, at least one anode 40 and at least one cathode 42 are accommodated within the battery cell housing 10.

Preferably, however, as can also be seen in FIG. 4, anode and cathode packs, which are also referred to as cell stacks, are accommodated in the battery cell housing. The respective cell stacks each consist of a plurality of anodes 40 or cathodes 42, with the anode stack and the cathode stack being electrically insulated from each other.

1. A battery cell housing for a prismatic battery cell having a housing shell and a housing base that is configured as a separate part, closes an open side of the housing shell and has a pressure compensation element integrated therein which is defined by at least one area the material thickness of which is reduced compared to an area directly adjacent thereto, the housing shell being made of a material different from a material from which the housing base is made, and the thickness of the housing shell being different from the thickness of the housing base.

2. The battery cell housing according to claim 1, wherein the pressure compensation element is defined by at least one line of weakness or includes a line of weakness.

3. The battery cell housing according to claim 2, wherein the line of weakness is a groove.

4. The battery cell housing according to claim 3, wherein the groove starts from an outer face of the battery cell housing.

5. The battery cell housing according to claim 3, wherein the groove is stamped into the housing base.

6. The battery cell housing according to claim 1, wherein the pressure compensation element is defined by a recessed, flat section in the housing base, the pressure element having a wall thickness that is smaller than the wall thickness of the rest of the housing base outside the pressure compensation element.

7. The battery cell housing according to claim 6, wherein the wall thickness of the pressure compensation element is 25-80% smaller than the wall thickness of the rest of the housing base.

8. The battery cell housing according to any of claim 2, wherein the pressure compensation element is defined by a recessed, flat section in the housing base, the pressure element having a wall thickness that is smaller than the wall thickness of the rest of the housing base outside the pressure compensation element, and the recessed, flat section forming the pressure compensation element includes the line of weakness at least in sections on its edge section.

9. The battery cell housing according to claim 8, wherein the line of weakness extends in a C- or U-shape.

10. The battery cell housing according to claim 1, wherein the housing shell is a U-shaped profile having an open side that is closed by the housing base.

11. The battery cell housing according to claim 1, wherein the housing shell has a smaller wall thickness than the housing base.

12. The battery cell housing according to claim 11, wherein the largest wall thickness of the housing base is twice to four times as large as the largest wall thickness of the housing shell.

13. The battery cell housing according to claim 1, wherein the pressure compensation element occupies a surface area of 10 to 30% of the total surface area of the outer face of the housing base.

14. The battery cell housing according to claim 1, wherein the pressure compensation element is designed to withstand a pressure of at least 2 bar.

15. The battery cell housing according to claim 1, wherein the housing base is a flat section which is connected to the edge of the housing shell on its opposite longitudinal sides.

16. The battery cell housing according to claim 1, wherein the housing base is made of a different metal or a different metal alloy than the housing shell.

17. The battery cell housing according to claim 16, wherein the housing base and the housing shell are welded to each other.

18. The battery cell housing according to claim 15, wherein, on its outer edge, the housing base has a shoulder in which the edge of the housing shell is seated.

19. The battery cell housing according to claim 1, wherein the housing base is a one-piece body and the pressure compensation element continues integrally and non-welded into the adjacent area of the housing base.

20. A battery cell comprising a battery cell housing according to claim 1 and at least one anode and at least one cathode, which are accommodated in the battery cell housing, the at least one anode and the at least one cathode being electrically insulated from each other.
